(19) United States
(12) Patent Application Publication
(10) Pub. No.: US 2026/0353474 A1
(43) Pub. Date: Nov. 5, 2026

(54) Silent Transmission Opportunity Sharing Among Virtual Interfaces

(71) Applicant: Apple Inc., Cupertino, CA (US)

(72) Inventors: Yanjun Sun, San Diego, CA (US); Oren Shani, Saratoga, CA (US); Anuj Batra, Redwood City, CA (US); Yong Ho Seok, Cupertino, CA (US); Yong Liu, Cupertino, CA (US); Charles F. Dominguez, San Carlos, CA (US); Veerendra Boodannavar, Cupertino, CA (US); Jarkko L. Kneckt, Los Gatos, CA (US); Min Young Park, San Ramon, CA (US)

(21) Appl. No.: 19/661,178

(22) Filed: Apr. 28, 2026

Related U.S. Application Data
(60) Provisional application No. 63/798,432, filed on May 1, 2025.

(51) Int. Cl. H04W 74/0833; H04W 84/12

(52) U.S. Cl. CPC H04W 74/085; H04W 84/12

(57) ABSTRACT

This disclosure relates to methods for silent transmission opportunity sharing among virtual interfaces in a wireless local area network. A first transmission can be performed on a link using a first virtual interface during a transmission opportunity. The transmission opportunity can be shared from the first virtual interface to a second virtual interface without over-the-air signaling. A second transmission can be performed on the link using the second virtual interface during the transmission opportunity. One or more of the virtual interfaces can operate as a non-access point station, at least in some instances.

### PRIORITY INFORMATION

This application claims priority to U.S. provisional patent application serial number 63/798,432, entitled “Silent Transmission Opportunity Sharing Among Virtual Interfaces,” filed May 1, 2025, which is hereby incorporated by reference in its entirety as though fully and completely set forth herein.

### TECHNICAL FIELD

The present application relates to wireless communication, including techniques and devices for silent transmission opportunity sharing among virtual interfaces in a wireless local area network.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In some cases, it can be possible for a wireless device to have multiple collocated virtual interfaces. It can also be possible for transmission opportunity sharing to be performed between stations in some wireless communication systems. However, existing techniques for transmission opportunity sharing require over-the-air control frame signaling between the stations, which can be inefficient if the stations are collocated. Accordingly, improvements in the field are desired.

### SUMMARY

Embodiments are presented herein of, inter alia, systems, apparatuses, and methods for a wireless device to silently share a transmission opportunity among its virtual interfaces in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a (“first”) virtual interface of the wireless device can obtain a transmission opportunity (TXOP), for example by way of medium contention or the TXOP being shared with the first virtual interface from an associated device via over-the-air (OTA) signaling. The first virtual interface can perform a transmission on a link during the TXOP. The first virtual interface can also share (e.g., a portion of) the TXOP silently (e.g., without OTA signaling) with another (“second” virtual interface of the wireless device, e.g., if the second virtual interface is cochannel collocated with the first virtual interface and is also capable of making use of the TXOP by transmitting on the link. Such silent TXOP sharing can facilitate use of the TXOP by the second virtual interface to also perform a transmission on the link during the TXOP.

Such silent TXOP sharing can be performed between virtual interfaces that operate in different station roles, in some embodiments. For example, it can be the case that at least one of the first virtual interface or the second virtual interface operates as a non-access point (AP) station. Such an interface can have an infrastructure connection with an AP station or have a peer-to-peer connection with a peer station, in various instances. It can also be possible for a virtual interface of a wireless device that performs TXOP sharing (e.g., provides TXOP sharing to another virtual interface or receives TXOP sharing from another virtual interface) to operate as an AP station.

The silent TXOP sharing can be subject to one or more rules, such as any of a variety of example rules described herein, e.g., to facilitate medium use fairness between stations sharing a medium (e.g., link) for wireless communication and/or for any of various other purposes. Additionally, or alternatively, any of a variety of techniques for performing silent TXOP sharing with features for improving user privacy can implemented, including any or all of the various example such techniques described herein, among other possibilities.

By avoiding at least some network signaling overhead, the silent TXOP sharing techniques described herein can thus potentially improve medium use efficiency, among various other benefits, at least according to some embodiments.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for silent transmission opportunity sharing among virtual interfaces in a wireless local area network, according to some embodiments;

FIG. 6 illustrates aspects of a system in which a physical device can have collocated virtual interfaces associated with a single physical transmitter/receiver;

FIG. 7 illustrates aspects of an example timeline in which a transmission opportunity can be silently shared among virtual interfaces of such a device as illustrated in FIG. 6, at least according to some embodiments;

FIG. 8 illustrates example aspects of a system in which a device that can share a transmission opportunity between fronthaul and backhaul interfaces when they are on the same link can operate, at least according to some embodiments; and

FIG. 9 illustrates aspects of an example timeline in which a transmission opportunity can be silently shared among virtual interfaces of such a device as illustrated in FIG. 8, at least according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium – Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium – a memory medium as described above, as well as a physical transmission medium, such as a bus, network, and/or other physical transmission medium that conveys signals such as electrical, electromagnetic, or digital signals.

Computer System – any of various types of computing or processing systems, including a personal computer system (PC), server-based computer system, wearable computer, network appliance, Internet appliance, smartphone, television system, grid computing system, or other device or combinations of devices. In general, the term "computer system" can be broadly defined to encompass any device (or combination of devices) having at least one processor that executes instructions from a memory medium.

User Equipment (UE) (or “UE Device”) – any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA) – any of various types of computer systems or devices that perform wireless communications. A wireless device can be portable (or mobile), or can be stationary or fixed at a certain location. The terms “station” and “STA” are used similarly. A UE is an example of a wireless device.

Communication Device – any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP) – The term "Base Station" has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor) – refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11 – refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to – Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

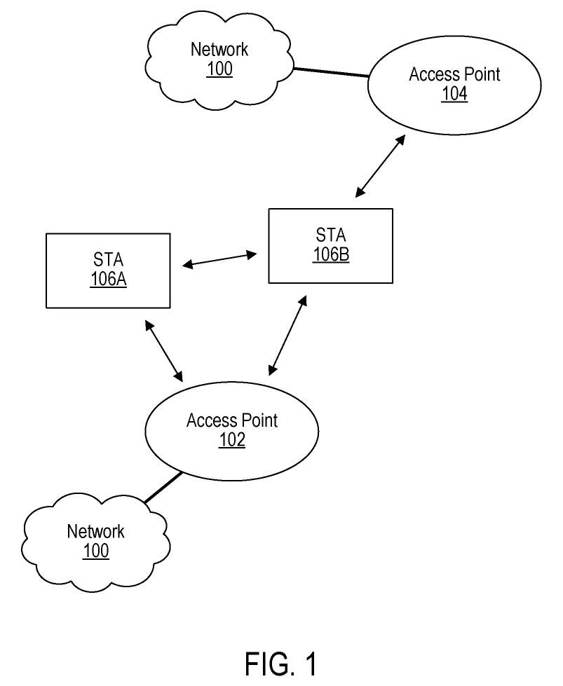

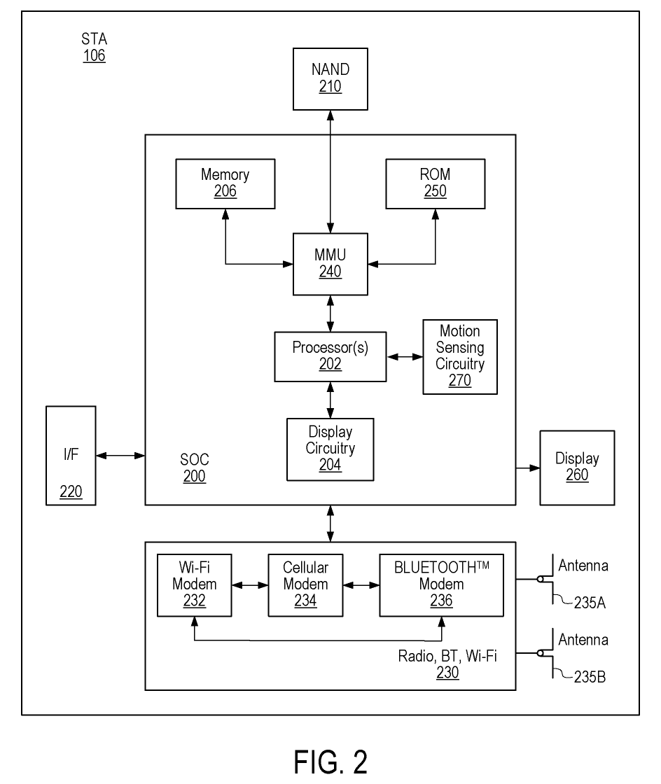

### FIGS. 1-2 – Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for silent transmission opportunity sharing among virtual interfaces in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2 – Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for silent transmission opportunity sharing among virtual interfaces described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

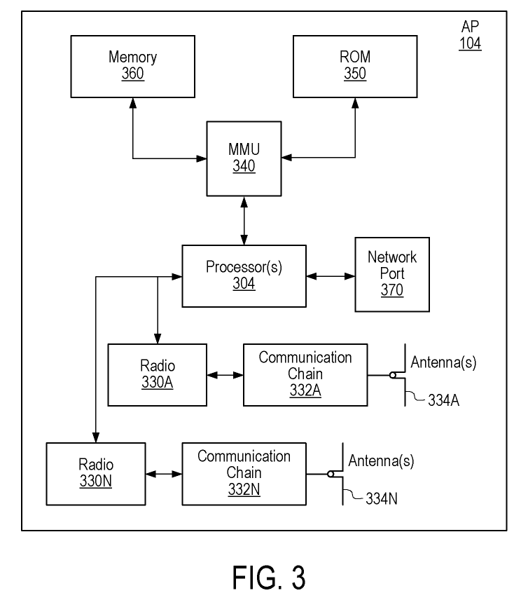

### FIG. 3 – Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as silent transmission opportunity sharing among virtual interfaces, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

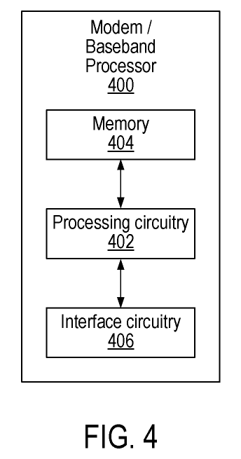

### FIG. 4 – Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio / transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as silent transmission opportunity sharing among virtual interfaces, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

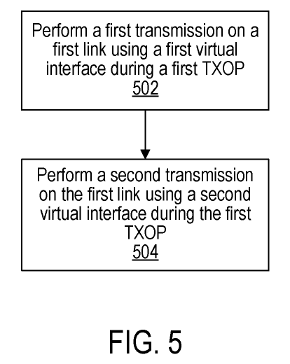

### FIG. 5 – Silent Transmission Opportunity Sharing Flowchart

FIG. 5 is a flowchart diagram illustrating a method for supporting silent transmission opportunity sharing among virtual interfaces in a WLAN communication system, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

A first transmission can be performed on a first link using a (“first”) virtual interface during a first transmission opportunity (TXOP) (502). The first TXOP can be silently (e.g., without over-the-air (OTA) signaling) shared with another collocated (“second”) virtual interface. A second transmission can be performed on the first link using the second virtual interface during the first TXOP (504). In some embodiments, the second transmission can be performed at a short interframe space (SIFS) or priority interframe space (PIFS) time after the first transmission, e.g., to chain network allocation vectors for the first and second transmissions and prevent interruption to the medium use during the first TXOP.

The first link can include a frequency channel such as a channel in the 2.4 GHz frequency band, the 5 GHz frequency band, or the 6 GHz frequency band. It may be the case that the first virtual interface and the second virtual interface are associated with the same wireless device and share the use of one or more physical aspects of the wireless device. For example, as one possibility, the first virtual interface and the second virtual interface can have any or all of a common operating class, channel, receive antenna connector, and transmit antenna connector. Thus, the first virtual interface and the second virtual interface can operate as cochannel collocated STAs, at least according to some embodiments.

It can be the case that at least one of the first virtual interface or the second virtual interface operates as a non-AP STA. For example, the first virtual interface and/or the second virtual interface can potentially have an infrastructure connection with an AP STA. It can also or alternatively be the case that one or both of the first virtual interface or the second virtual interface can have a peer-to-peer connection with a peer station. In some embodiments, one of the first virtual interface or the second virtual interface could operate as an access point station; for example, the first and second virtual interfaces could include a backhaul non-AP STA interface associated with an AP STA and a fronthaul AP STA interface associated with one or more non-AP STAs.

The first TXOP can be obtained in any of multiple possible ways. As one possibility, the first TXOP can be obtained via medium contention by the first virtual interface or the second virtual interface. As another possibility, the first TXOP can be shared with the first virtual interface or the second virtual interface by a station associated with that virtual interface; for example, the first virtual interface could receive an indication that the first TXOP is shared with the first virtual interface from a station associated with the first virtual interface, or the second virtual interface could receive an indication that the first TXOP is shared with the second virtual interface from a station associated with the second virtual interface.

The duration of one or more of the first transmission or the second transmission can be subject to one or more constraints, for example to conform with the rules configured for the wireless communication systems in which both the first virtual interface and the second virtual interface operate. Thus, for example, the duration of one or more of the first transmission or the second transmission can be determined based at least in part on one or more of a primary access category (AC) with which the TXOP is obtained, one or more ACs associated with one or more frames in the first transmission, one or more ACs associated with one or more frames in the second transmission, a TXOP limit associated with the first virtual interface, a TXOP limit associated with the second virtual interface, or a remaining duration of the first TXOP when the first TXOP is obtained by the first virtual interface (e.g., whether the first TXOP is shared to the first virtual interface by a station that is not co-located with the first virtual interface or obtained directly by the first virtual interface), according to various embodiments. There can also be a constraint on the ACs allowed in the first and second transmissions; for example, the one or more ACs associated with the one or more frames in the second transmission can be required to have equal or higher priority than the primary AC, in some embodiments.

It can be the case that silent TXOP sharing among co-located virtual interfaces is subject to one or more rules to prevent a station from grabbing the medium aggressively with one virtual interface (e.g., and transmitting a dummy frame, such as a CTS, or a very short data frame, as possible examples) only for the purpose of sharing the TXOP with another co-located virtual interface. For example, it can be the case that the first transmission includes at least one of a unicast data or management frame transmission, and/or is performed for at least a minimum configured duration. In this case, such minimum requirements being met can be a condition for the first virtual interface to silently share a portion of the TXOP with the second virtual interface, at least according to some embodiments.

There can be multiple ways for the second virtual interface to manage its backoff counter in view of being able to perform the second transmission during the first TXOP. As one possibility, the backoff counter for the second virtual interface for the access category or categories associated with the second transmission can be reset based at least in part on performing the second transmission. As another possibility, the backoff counter for the second virtual interface for the access category or categories associated with the second transmission can be paused during the second transmission and resumed after the second transmission. Other techniques can also be possible.

According to various embodiments, it can be possible that the first transmission includes duration information configured to provide network allocation vector protection for the duration of the first transmission, or beyond the duration of the first transmission. In the latter case, for example, duration information configured to provide network allocation vector protection additionally for the duration of the second transmission could be included in the first transmission. In such a scenario, the first transmission could further include one or more of an indication to a station associated with the second virtual interface to stay awake for the second transmission or second duration information configured to indicate the duration of the first transmission, e.g., which can be used by the station associated with the second virtual interface to determine when to wake for the second transmission.

In some embodiments, it can be possible that the second transmission is performed at a random or quasi-random interval after the first transmission (e.g., for privacy reasons, to reduce the likelihood that the first virtual interface and the second virtual interface can be identified as belonging to the same physical device by an eavesdropper). In such a scenario, it could be the case that the first transmission includes duration information configured to provide network allocation vector protection for the duration of the first transmission and the random or quasi-random interval after the first transmission.

Another potential user privacy protection technique could include using a randomized media access control address for one or more of the first virtual interface or the second virtual interface during the first TXOP, e.g., based at least in part on the first TXOP being shared between the first virtual interface and the second virtual interface.

In some scenarios, it can be important to prevent incoming frames addressed to the first virtual interface after the first virtual interface shares its remaining TXOP to the second virtual interface (e.g., if the second virtual interface transmits at very low power and may allow a station associated with the first interface, such as an associated AP, to mistakenly determine that the medium is idle (e.g., due to idle medium indicated by clear channel assessment (CCA)). For example, in such a scenario, absent preventative measures, the associated AP could subsequently transmit a frame to the first virtual interface, which could fail due to the second transmission being performed by the second virtual interface.

One option to address this can include the first interface indicating unavailability information to the peer of the first virtual interface. The unavailability information (e.g. carried in an Initial Control Frame or Multi-STA Block frame such as defined in IEEE 802.11bn) can potentially prevent the peer from transmitting frames to the first virtual interface during the portion of the TXOP shared to the second virtual interface.

As another option, the second virtual interface can disallow the peer of the first virtual interface by transmitting a frame to set the NAV (e.g., by a CTS-to-Self frame) and/or disable spatial reuse (e.g., by indicating:
SR_AND_NON_SRG_OBSS_PD_PROHIBITED in the physical layer (PHY) header)
in the PHY protocol data unit (PPDU) which the second virtual interface transmits. The second transmission can also or alternatively include any of various other types of information configured to prevent transmission to the first virtual interface during the second transmission, according to various embodiments.

As a further option, a STA can provide a list of virtual interfaces associated with the STA to a peer. Based on such a list, the peer can be configured to not transmit to the first virtual interface associated with the STA if the peer detects frames for the second virtual interface associated with the STA.

Note that such silent TXOP sharing can also be performed among more than two cochannel collocated virtual interfaces of a wireless device, in some embodiments. For example, it can also be possible for a third transmission to be performed on the first link using a third virtual interface (e.g., that also shares a physical transmitter with the first and second virtual interfaces) during the first TXOP, at least as one possibility.

Note that, according to various embodiments, it can be possible to use the silently shared TXOP portions in any of a variety of ways. In some instances, for example, one or both of the first transmission and the second transmission can be used to transmit data to an associated station. As another possibility, one or both of the first transmission and the second transmission can include trigger frames configured cause an associated station to transmit data to the corresponding virtual interface. For example, in some instances, the second transmission can include a trigger frame configured to trigger an uplink transmission from a station associated with the second virtual interface.

Thus, according to the method of FIG. 5, it can be possible to silently share a TXOP between virtual interfaces of a wireless device, which can potentially improve medium use efficiency and reduce network signaling overhead, among various possible benefits, at least according to some embodiments.

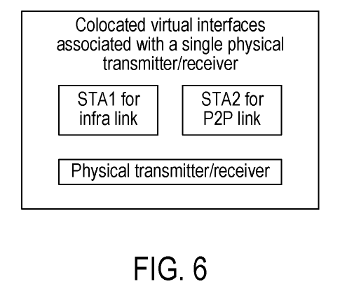

### FIGS. 6-9 and Additional Information

FIGS. 6-9 illustrate further aspects that might be used in conjunction with the method of FIG. 5. It should be noted, however, that the exemplary details illustrated in, and described with respect to, FIGS. 6-9 are not intended to be limiting to the disclosure as a whole: numerous variations and alternatives to the details provided herein below are possible and should be considered within the scope of the disclosure.

In IEEE 802.11 based wireless communication systems, it can be the case that certain clients are challenged by beacon frames with a higher number of octets. To address this, a collocated basic service set identifier (BSSID) set with multiple SSIDs/BSSIDs/virtual APs can be enabled via multiple MBSSID beacons. In other words, a co-hosted set of multiple BSSID sets can be provided by the same physical device, in some instances.

Applying co-time division multiple access (TDMA) protocol to such collocated BSSs can lead to inefficient and/or counterintuitive behavior, in some instances. For example, it could be the case that a virtual interface performs an over the air (OTA) transmission (e.g., a MU-RTS TXS) to grant a portion of a TXOP to another virtual interface in the same physical device, which in turn could respond (e.g., with a CRF), in which case both frames could be transmitted by the same radio that receives neither frame.

Providing support for virtual interfaces of a physical device to silently share a TXOP (e.g., without OTA transmission to hand over a portion of the TXOP) could thus potentially streamline and improve the efficiency of wireless communications in such a system, at least according to some embodiments.

Further, it can potentially be beneficial to support such silent TXOP sharing not only between virtual interfaces operating as AP stations, but also including with virtual interfaces operating as non-AP stations. For example, at least in some Wi-Fi implementations, multiple virtual interfaces can share a physical transmitter/receiver, e.g., having a common operating class, channel, receive antenna connector, and transmit antenna connector. As an example on the non-AP STA side, FIG. 6 illustrates aspects of a system in which a physical device can have collocated virtual interfaces associated with a single physical transmitter/receiver, where one virtual interface implements a non-AP STA configured for an infrastructure (infra) link with an AP STA and another virtual interface implements a STA configured for a peer-to-peer (P2P) link with a peer STA.

Thus, at least according to some embodiments, silent TXOP sharing among virtual interfaces can be generalized for both AP STAs and non-AP STAs transmissions. For example, it can be specified that two or more virtual interfaces (potentially including a non-AP STA) can share a TXOP among them without explicit signaling over the air by using bursts of transmissions (e.g., the spacing between the bursts can be SIFS (i.e., SIFS bursting), PIFS, or even longer, as long as the medium is secured by physical or virtual carrier sensing. The sharing can follow one or more of the rules described herein, at least according to some embodiments.

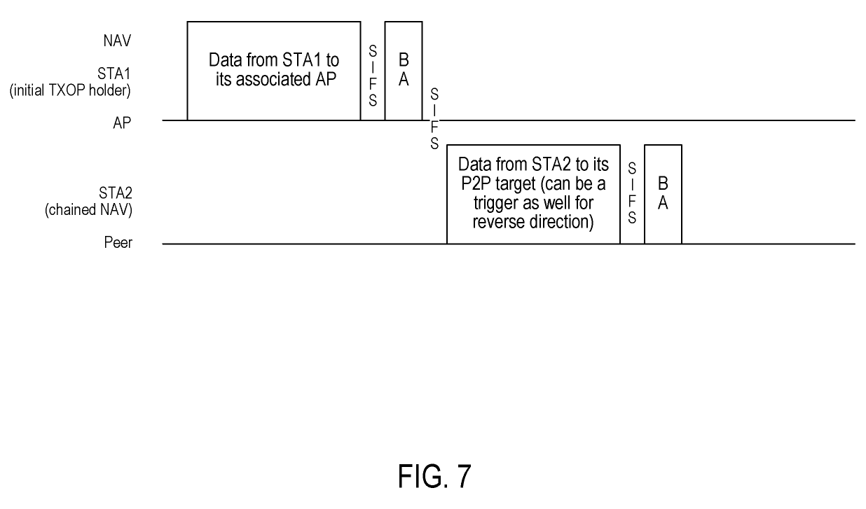

There can be multiple ways for the TXOP that is shared to be initially obtained by the device performing the sharing among its virtual interfaces. As one possibility, the TXOP can be won by one of the virtual interfaces of the device (e.g., via medium contention) or shared by another peer STA. As another possibility, An infra non-AP STA can receive a TXOP shared by its associated AP and then share it with another collocated STA during the shared TXOP. FIG. 7 illustrates aspects of an example timeline in which a TXOP can be silently shared among virtual interfaces of a device with SIFS bursting to protect the medium during the chained NAV, at least according to some embodiments.

One set of rules that silent TXOP sharing among virtual interfaces on the same physical link can follow can relate to the total duration. For example, it can be the case that the total duration is required to not exceed the TXOP limit (associated with the primary AC won by the TXOP holder (e.g., if a 5ms TXOP is won by STA1, then the sum of the airtime used by TXOP owner STA1 and the airtime shared to other STA(s) (virtually on the same device or a separate device) can be limited to 5ms). If the TXOP is received from another STA (e.g., a TXOP received from a TX sharing (TXS) feature, such as defined in IEEE 802.11be), it can be the case that the sum of the sharing on the virtual interfaces shall not exceed the shared duration indicated in the TXS frame (e.g., 2.5ms of a 5ms TXOP could be shared, as one example). If a STA that receives a shared TXOP has a TXOP limit shorter than the duration of the shared TXOP, the STA can potentially be required to limit its TXOP usage, e.g., so that it obeys rules of both wireless communication systems.

In some instances, if the TXOP limit is 0 for the AC, it can be the case that the silent TXOP sharing shall be disallowed. During a shared portion of the TXOP, it can be the case that a virtual interface (e.g., STA2) can only send traffic with a priority equal to or above that of the primary AC. It can be required that a STA that obtains a TXOP (e.g., STA1) shall use a portion of the TXOP for meaningful data or management frame exchange (for example, to avoid the possibility to grab the medium with some dummy frame (such as RTS, CTS) just for the sake of TXOP sharing to another STA (virtually on the same device or a separate device).

After using a shared TXOP, it can be the case that a virtual interface is expected to perform one of the following on the AC(s) for which any MPDU has been transmitted: 1) reset the backoff counter (contention window may reuse the previous one or a contention window min value if a transmission is successful); or 2) resume the previous backoff counter from before it received the shared TXOP.

As one NAV protection rule option, it can be the case that one virtual interface shall not protect the NAV beyond its intended frame exchange(s). This can potentially prevent a target STA of the next virtual interface from sleeping after observing a longer-than-needed NAV, in which case the next virtual interface could get the shared TXOP and transmit to the target STA but the transmission can fail. As another NAV protection rule option, it can be the case that one virtual interface can protect the NAV (duration field) beyond its intended frame exchange(s). In this case, it can be required that the virtual interface shall include an indication for the target STA of the next virtual interface to stay awake (e.g., use one or more bits or explicitly use the target STA’s MAC address in the frame exchange (such as ICF or MPDU/PPDU header)). Alternatively, the frame can indicate the true projected TXOP end time in a separate field (e.g., in a separate indication in the frame).

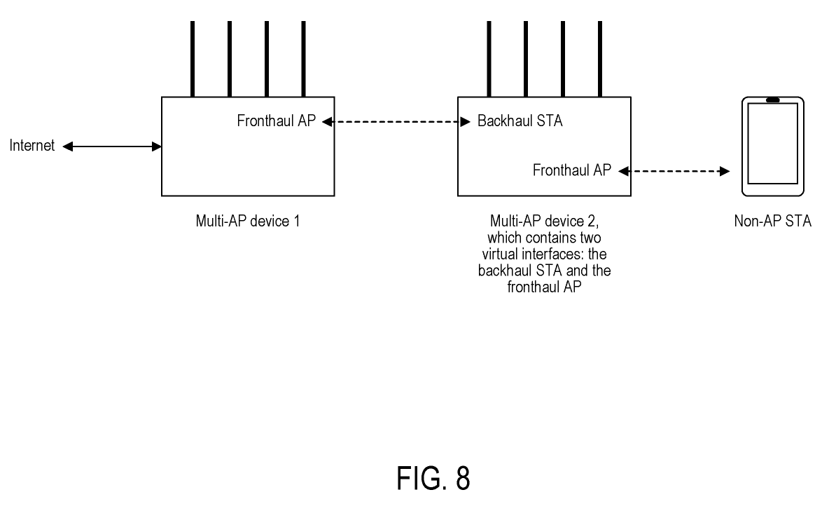

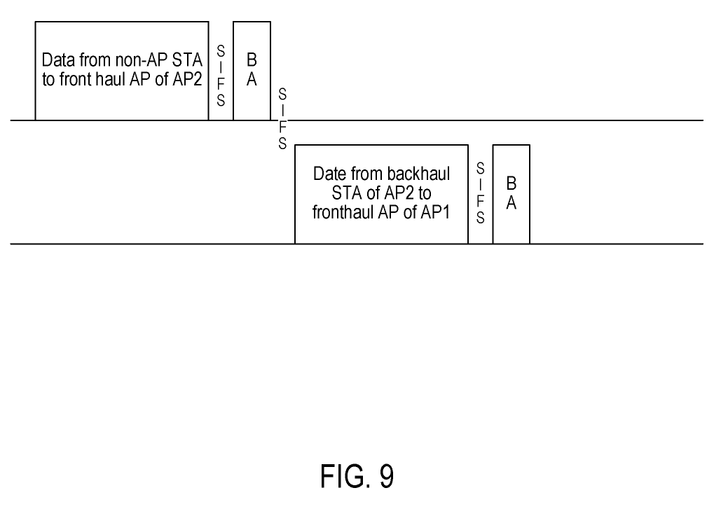

Another use case for silent TXOP sharing among virtual interfaces of the same device can include a device that shares a TXOP between fronthaul (e.g., AP) and backhaul (e.g., non-AP) interfaces when they are on the same link. The fronthaul and backhaul interfaces can be two virtual interfaces on the same link in this case, and any or all of the rules previously described herein can also apply, at least according to some embodiments. FIG. 8 illustrates example aspects of a system in which such a device can operate, at least according to some embodiments. FIG. 9 illustrates aspects of an example timeline in which a TXOP can be silently shared among virtual interfaces of such a device with SIFS bursting to protect the medium during the chained NAV.

One possible general rule to avoid collisions among the SIFS bursts enabled by such a mode can include that only one physical transmitter can perform such silent sharing at a time. For example, it could be possible for the virtual interfaces of the AP1 device illustrated in FIG. 1 to silently share before AP1 shares its TXOP to AP2. After the sharing, it can be required that no virtual interface of AP1 use such silent sharing – only the virtual interfaces of AP2 can silently share during the portion of the TXOP shared to AP2. After AP2 returns the shared TXOP back to AP1, then AP2’s virtual interfaces cannot silently share the TXOP anymore, and AP1’s virtual interfaces may silently share the TXOP again. It can be the case that if a STA gets a shared TXOP based on the TXS Mode 1 defined in IEEE 802.11be, the STA shall not perform such silent sharing among its virtual interfaces, as one possibility. It can also or alternatively be the case that if a STA gets a shared TXOP based on the TXS Mode 2 defined in IEEE 802.11be, the STA can perform such silent sharing among its virtual interfaces. If the STA intends to return the TXOP, it can be the case that the virtual interface that originally receives the shared TXOP from the AP shall transmit a frame with a CAS Control field to the AP, at least as one possibility.

In some instances, user privacy considerations can inform the operation of silent TXOP sharing among virtual interfaces of a device. For example, if SIFS bursting is used between virtual interfaces, it could potentially allow an observer to learn that two MAC addresses belong to the same physical interface. To make it harder for such an observer to track the correlation, it can be possible for a STA to perform one or more of multiple options. As one option, randomized addresses can be used for any or all of the virtual STA interfaces. As another option, a STA can choose to not always use the SIFS interval; for example, silent TXOP sharing could be performed in one TXOP, and selectively not used in another TXOP. As a further option, a random or quasi-random interval could be introduced between the bursts on different virtual interfaces. In this case, to hold the medium, a first virtual interface can set the duration field to a small non-zero value in the MPDUs it transmits, so that the duration field helps to hold/protect the medium even if a second virtual interface starts its transmission more than SIFS later (although it may still need to be within the time protected by the Duration field).

As an example, it could be the case that some or all of the following text could be used to specify support for silent TXOP sharing, e.g., in IEEE 802.11 and/or other technical specifications for a wireless communication system supporting such silent TXOP sharing: An STA that wins contention-based access to the medium or receives a shared TXOP may silently (i.e., with no OTA control frames) pass a portion of the TXOP to one or more other cochannel collocated STAs (a set of STAs that use a common operating class, channel, receive antenna connector, transmit antenna connector, and co-hosted BSSID is an example of such). TXOP portions are separated by SIFS. Each STA protects its portion of the TXOP up to, but not including, the trailing SIFS of its TXOP portion. The TXOP is subject to the fairness requirements based on one or more rules defined for silent TXOP sharing. It should be noted that numerous variations and alternatives to this example text are also possible.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
performing a first transmission on a first link using a first virtual interface during a first transmission opportunity (TXOP); and
performing a second transmission on the first link using a second virtual interface during the first TXOP,
wherein the first TXOP is shared from the first virtual interface to the second virtual interface without over-the-air (OTA) signaling, and
wherein at least one of the first virtual interface or the second virtual interface operates as a non-access point (AP) station.

2. The method of claim 1,
wherein at least one of the first virtual interface or the second virtual interface has an infrastructure connection with an access point (AP) station.

3. The method of claim 1,
wherein at least one of the first virtual interface or the second virtual interface has a peer-to-peer connection with a peer station.

4. The method of claim 1,
wherein one of the first virtual interface or the second virtual interface operates as an AP station.

5. The method of claim 1, wherein the method further comprises at least one of:
obtaining the first TXOP via medium contention by the first virtual interface; or
receiving, from a station associated with the first virtual interface, an indication that the first TXOP is shared with the first virtual interface.

6. The method of claim 1, wherein the method further comprises:
determining a duration for one or more of the first transmission or the second transmission based at least in part on one or more of:
a primary access category (AC) with which the TXOP is obtained;
one or more ACs associated with one or more frames in the first transmission;
one or more ACs associated with one or more frames in the second transmission;
a TXOP limit associated with the first virtual interface;
a TXOP limit associated with the second virtual interface; or
a remaining duration of the first TXOP when the first TXOP is shared to the first virtual interface by a station that is not co-located with the first virtual interface.

7. The method of claim 6,
wherein the one or more ACs associated with one or more frames in the second transmission have equal or higher priority than the primary AC.

8. A processor comprising memory configured to cause the processor to perform operations comprising:
generating signals configured for a first transmission on a first link using a first virtual interface during a first transmission opportunity (TXOP); and
generating signals configured for a second transmission on the first link using a second virtual interface during the first TXOP,
wherein at least one of the first virtual interface or the second virtual interface operates as a non-access point (AP) station.

9. The processor of claim 8, wherein the signals configured for the first transmission include at least one of:
a unicast data or management frame transmission; or
a minimum duration configured for TXOP use before silent TXOP sharing.

10. The processor of claim 8, wherein the second transmission is associated with at least a first access category, wherein the memory is further configured to cause the processor to perform operations comprising:
resetting a backoff counter for the second virtual interface for the first access category based at least in part on the second transmission.

11. The processor of claim 8, wherein the second transmission is associated with at least a first access category, wherein the memory is further configured to cause the processor to perform operations comprising :
pausing a backoff counter for the second virtual interface for the first access category during the second transmission; and
resuming the backoff counter for the second virtual interface for the first access category after the second transmission.

12. The processor of claim 8,
wherein the signals configured for the first transmission include duration information configured to provide network allocation vector protection for a duration of the first transmission.

13. The processor of claim 8,
wherein the signals configured for the first transmission include duration information configured to provide network allocation vector protection beyond a duration of the first transmission,
wherein the signals configured for the first transmission further include one or more of an indication to a station associated with the second virtual interface to stay awake for the second transmission or second duration information configured to indicate the duration of the first transmission.

14. A wireless device, comprising:
one or more antennas;
a radio operably coupled to the one or more antennas; and
a processor operably coupled to the radio;
wherein the wireless device is configured to:
perform a first transmission on a first link using a first virtual interface during a first transmission opportunity (TXOP); and
perform a second transmission on the first link using a second virtual interface during the first TXOP,
wherein at least one of the first virtual interface or the second virtual interface operates as a non-access point (AP) station.

15. The wireless device of claim 14,
wherein the first virtual interface and the second virtual interface have a common operating class, channel, receive antenna connector, and transmit antenna connector.

16. The wireless device of claim 14, wherein the wireless device is further configured to:
use a randomized media access control address for one or more of the first virtual interface or the second virtual interface during the first TXOP based at least in part on the first TXOP being shared between the first virtual interface and the second virtual interface.

17. The wireless device of claim 14,
wherein the second transmission is performed at a random or quasi-random interval after the first transmission,
wherein the first transmission includes duration information configured to provide network allocation vector protection for a duration of the first transmission and the random or quasi-random interval after the first transmission.

18. The wireless device of claim 14,
wherein the second transmission is performed at a short interframe space (SIFS) or priority interframe space (PIFS) time after the first transmission.

19. The wireless device of claim 14, wherein the wireless device is further configured to provide, using the first virtual interface, to a station associated with the first virtual interface, at least one of:
information indicating unavailability of the first virtual interface during the second transmission; or
information indicating one or more virtual interfaces associated with the first virtual interface; or
wherein the second transmission comprises information configured to prevent transmission to the first virtual interface during the second transmission .

20. The wireless device of claim 14,
wherein the second transmission comprises a trigger frame configured to trigger an uplink transmission from a station associated with the second virtual interface.
